(19) United States
(12) Patent Application Publication
(10) Pub. No.: US 2008/0251421 A1
(43) Pub. Date: Oct. 16, 2008

(54) Desalting Process

(75) Inventors: Jon Liverud, Oslo (NO); Arne Myrvang Gulbraar, Sofiemyr (NO)

Correspondence Address: GOODWIN PROCTER LLP;PATENT ADMINISTRATOR, EXCHANGE PLACE, BOSTON, MA, 02109-2881, US

(73) Assignee: Kvaerner Process Systems A.S., Lysaker (NO)

(21) Appl. No.: 11/631,252

(22) PCT Filed: Jun. 30, 2005
(86) PCT No.: PCT/IB2005/002557

§ 371 Date: Jan. 24, 2008

(30) Foreign Application Priority Data
Jun. 30, 2004 (GB) 0414600.7

(51) Int. Cl. C10G 33/02; B03C 5/02

(52) U.S. Cl. 208/187; 204/660

(57) ABSTRACT

A compact desalting system for use in a process of desalting crude oil comprises a plurality of separation stages. Each separation stage includes a compact electrostatic coalescer (42, 62) for coalescing water droplets carried with the crude oil and settling means (91, 92; 95, 96) for settling separated oil and coalesced water droplets. The system includes a vessel (46) comprising a plurality of compartments containing the settling means and the compact electrostatic coalescers are each mounted in a housing on top of the vessel.

The present invention relates to a desalting process. More particularly, the present invention relates to a method and apparatus for desalting of a crude oil stream.

Crude oil is extracted from a well as a stream of fluids, which include not only the crude oil but also other components such as water and gas. The well stream will also contain unwanted salts. These are carried in solution in the water. The proportions of water and oil in the well stream may vary according to the circumstances of the particular well and over field life. Particularly in the early production phase of a well, water will normally be in the form of droplets carried in the oil. Before the crude oil can be exported, there is a need to remove as much of the water and the salts as possible. Separating the water from the oil will remove most of the salts because these are dissolved in the water. However, it is not feasible to separate all of the water from the oil, but the salt concentration in the oil can be reduced to an acceptable level by adding more, less saline water and then separating the water from the crude oil. This procedure effectively flushes out more salt, and may be done as part of a two-stage separation process.

In general, each separation stage includes a device for coalescing the water droplets, followed by a settling vessel in which the separated water falls to the bottom of the vessel, while the lighter oil settles on top. The water and oil are then removed from the vessel through separate outlets.

A typical two-stage desalting process will consist of two separation stages in a serial configuration, and injection of freshwater or dilution water in between. Problems arise with this equipment because each settling vessel is large and heavy. Interconnecting pipes and other equipment also contribute to the overall size and weight. Frequently, the desalting process must be carried out on an offshore production platform, where space and weight are at a premium.

It is an aim of the present invention to provide an improved desalting process, which alleviates the aforementioned problems.

According to a first aspect of the present invention there is provided a compact desalting system for use in a process of desalting crude oil comprising a plurality of separation stages, each separation stage including a compact electrostatic coalescer for coalescing water droplets carried with the crude oil and settling means for settling separated oil and coalesced water droplets, wherein the system includes a vessel comprising a plurality of compartments containing said settling means and said compact electrostatic coalescers are each mounted in a housing on top of said vessel.

According to a second aspect of the present invention there is provided a compact desalting system for use in a process of desalting crude oil comprising a plurality of separation stages, each separation stage including a compact electrostatic coalescer for coalescing water droplets carried with the crude oil and settling means for settling separated oil and coalesced water droplets, wherein the system includes a vessel comprising a plurality of compartments containing said settling means and said compact electrostatic coalescers are each mounted in a housing separate from said vessel.

Preferably at least one of said separation stages includes bypass means for isolating said compact electrostatic coalescer to permit maintenance of the coalescer without stopping operation of the desalting process.

Advantageously, the compact electrostatic coalescers include insulated electrodes tolerating high water cuts and water slugs without short circuiting the electrodes. Furthermore, the compact electrostatic coalescers may be configured to include a turbulent flow pattern for improved coalescence of water droplets.

According to a third aspect of the present invention there is provided a method of desalting a crude oil stream in a plurality of separation stages, comprising: electrostatically coalescing water droplets carried in the crude oil stream in a first compact electrostatic coalescer and then separating the coalesced water droplets from the oil in a first compartment of a vessel; and electrostatically coalescing water droplets carried in the crude oil stream in a second compact electrostatic coalescer and then separating the coalesced water droplets from the oil in a in a second compartment of said vessel.

It is an advantage that, by providing separate compartments in the vessel, an effective desalting process having more than one separator stage can be achieved using a single vessel apparatus. This results in a substantial reduction in the size and weight of the equipment, when compared to known two-stage processes having separate vessels for each stage.

Advantageously, the use of compact electrostatic coalescers reduces the size of the coalescers when compared, for example, with up-flow coalescers. This means that each separation stage is small enough for a single settling vessel to be sited underneath both of the coalescers.

In a preferred embodiment, means may be provided for mixing dilution water into the crude oil. The mixing means may include a static mixer. The mixer should also be used in combination with a valve.

Preferably, the dilution water is added to the crude oil after the first separator stage and before the second separator stage. Alternatively, or additionally, the dilution water may be added to the crude oil before it enters the first separator stage.

It is an advantage that by mixing dilution water with the crude oil, or by recycling water from the second stage outlet, the process can be controlled for optimum desalting performance. It is a further advantage that the compact electrostatic coalescer can perform with a very low water to oil ratio, thereby reducing the quantity of dilution water required.

In one embodiment, water from an outlet of the second separator stage is recycled to be mixed with the crude oil before the inlet to the first separator stage. It is an advantage that, by using recycled water the amount of water required from a separate supply is reduced.

According to a further aspect of the present invention there is provided a settling vessel for a compact crude oil desalting process having a plurality of separation stages, the settling vessel comprising a first compartment containing at least part of a first separation stage and a second compartment containing at least part of a second separation stage, the first and second compartments each having separate outlets for oil and water, and wherein the first compartment has a first inlet and the second compartment has a second inlet, the first and second inlets being arranged such that compact electrostatic coalescers are mountable directly on top of the vessel.

In a preferred embodiment, the vessel is of a generally cylindrical form and has a dividing plate dividing the vessel into said first and second compartments. In one embodiment the dividing plate is a vertical plate extending the entire length of the vessel. In another embodiment the dividing plate is a horizontal plate, the first and second compartments being an upper compartment and a lower compartment.

Embodiments of the invention will now be described with reference to the accompanying drawings, in which:

FIG. 1 is a schematic representation of a known two-stage desalting process;

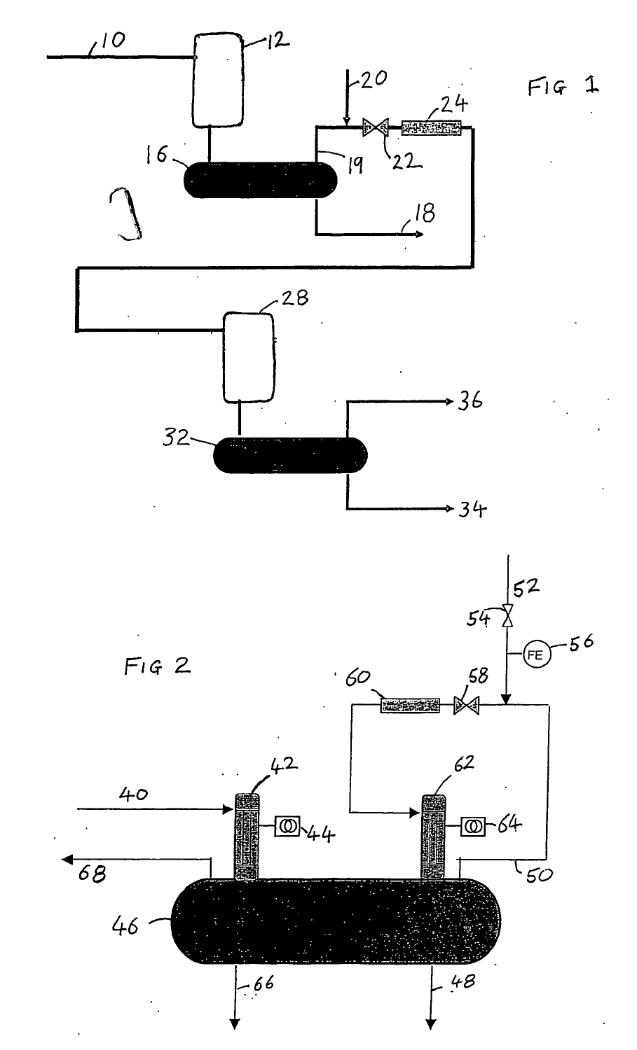

FIG. 2 is a schematic representation of a first embodiment of a two-stage compact desalting process;

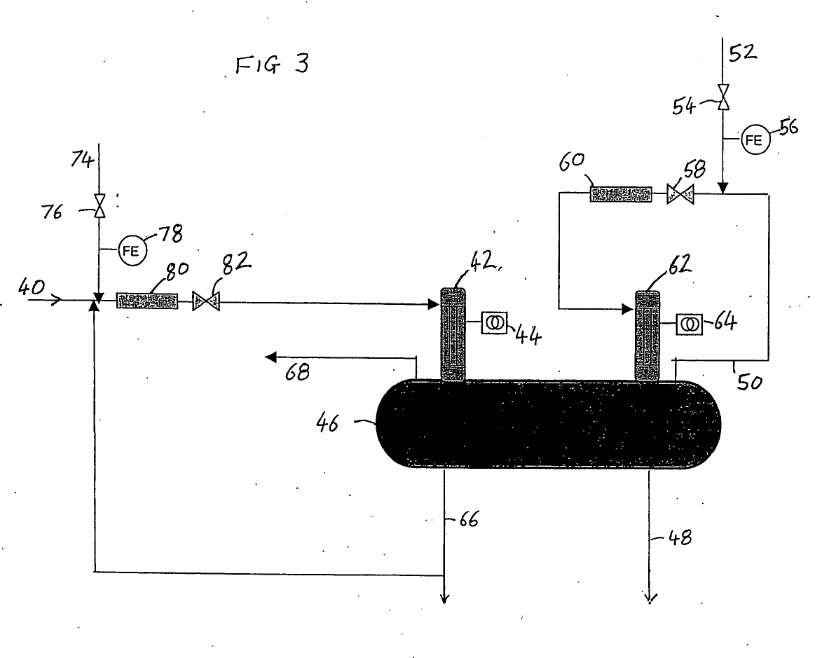

FIG. 3 is a schematic representation of a second embodiment of two-stage compact desalting process;

FIG. 4 is a cross-sectional view through a first embodiment of a settling vessel forming part of a compact desalting apparatus;

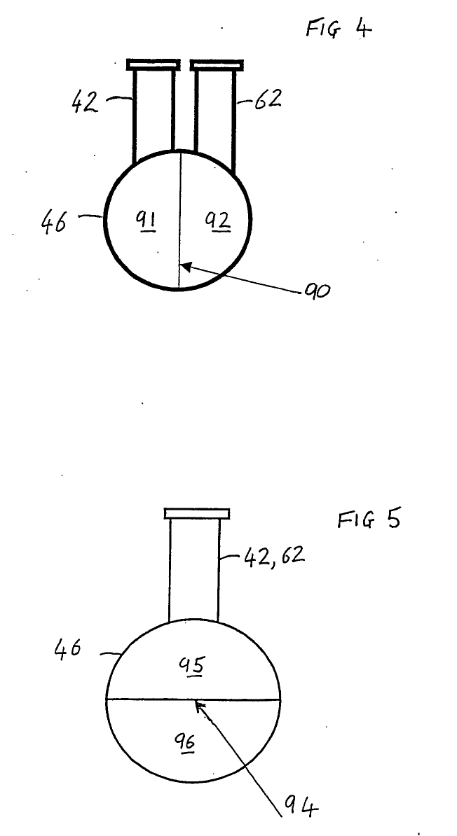

FIG. 5 is a cross-sectional view through a second embodiment of a settling vessel forming part of a desalting apparatus;

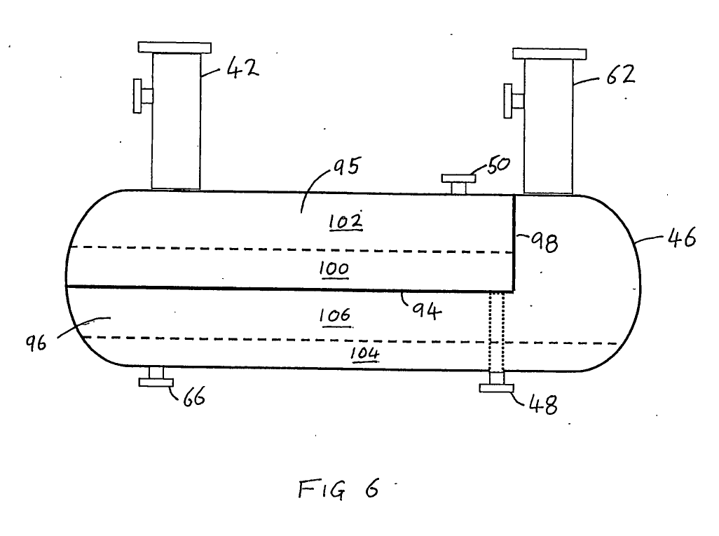

FIG. 6 is a sectional side elevation of the settling vessel of FIG. 5;

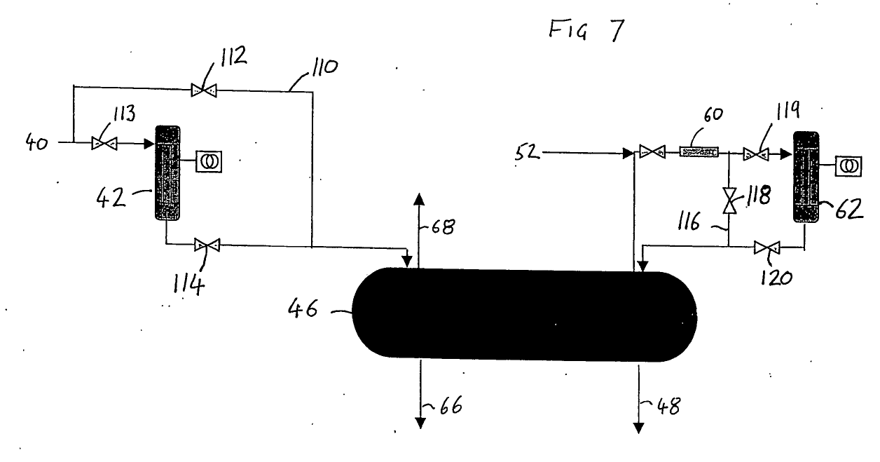

FIG. 7 is a schematic representation of a third embodiment of two-stage compact desalting process; and

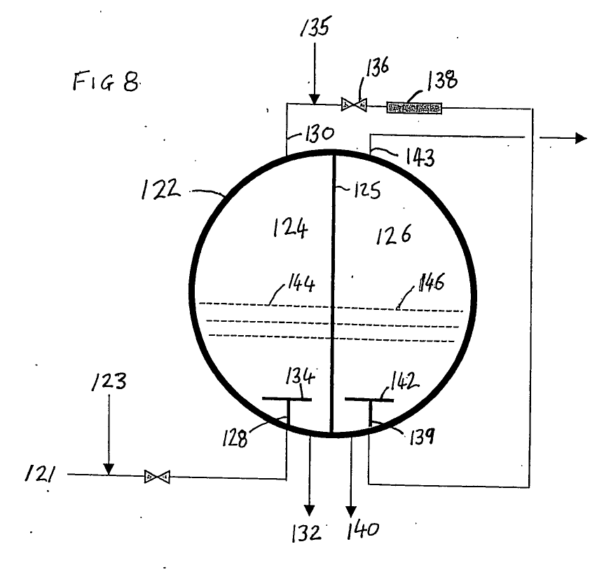

FIG. 8 is a cross-sectional view through a vessel forming part of a further embodiment of a desalting apparatus.

Referring to FIG. 1, a two-stage desalting process is shown for removing salt from a crude oil stream 10. The crude oil stream 10 typically comprises crude oil, together with water in the form of droplets carried in the oil. Because the salts carried in the crude oil stream dissolve more readily in water, the water droplets contain dissolved salts that need to be removed before the crude oil can be exported. The crude oil stream 10 comes from a separator, which has removed the majority of gas, solids (such as sand) and any free water that is not carried in the form of droplets in the oil.

The crude oil stream 10 enters a first stage coalescer 12, where the salty water droplets are coalesced to form larger droplets so that these can be more readily separated from the oil. The oil and coalesced salty water droplets are then fed into a first-stage settling vessel 16. The heavier water droplets fall to the bottom of the first-stage settling vessel 16, while the lighter oil resides on top. The salty water is removed through a first stage water outlet 18 in the bottom of the first stage settling vessel 16. The removal of the water through the first stage water outlet 18 takes with it a substantial proportion of the salts.

The oil in the first stage settling vessel 16 is removed through a first stage oil outlet 19. Although most of the salty water droplets have been removed from the oil in the first stage, a significant proportion are still carried with the oil. Dilution water 20 is added to the process and the fluids are mixed by being fed through a valve 22 and a static mixer 26, which ensure good mixing of salty water droplets carried with the oil and droplets of dilution water.

Droplets of salty water and dilution water are carried with the oil into a second stage coalescer 28, where the diluted salty water droplets (salty and dilution) are coalesced to form larger droplets. The oil and coalesced water droplets are fed into a second stage settling vessel 32, where the water falls to the bottom and is removed through a second stage water outlet 34, carrying with it dissolved salts. At this stage a high proportion of the salts have been removed from the oil. The desalted oil is removed through an oil outlet 36 to a storage tank or further oil processing plant (not shown).

Referring to FIG. 2, a two-stage separation process, similar to that shown in FIG. 1, is used to remove salt from a crude oil stream 40 (which would be equivalent or similar to the crude oil stream 10 shown in FIG. 1). The crude oil stream 40 enters a first compact electrostatic coalescer 42, where the water droplets are coalesced before the stream enters a settling vessel 46. The compact electrostatic coalescer 42 is supplied with a voltage from an electrical transformer 44 to generate an electrostatic field that coalesces the water droplets.

The settling vessel 46 has two compartments and the oil and water stream from the first stage coalescer 42 enters a first compartment. The oil and water in the first compartment separate from each other, as described above for the settling vessels 16, 32 of FIG. 1. Separated water is removed from the first compartment through a first stage water outlet 48. Oil, which has been separated in the first stage of the separation process, is taken from the first compartment through a first stage oil outlet 50.

Dilution water from a dilution water supply 52 is mixed into the oil in a static mixer 60 and valve 58. The flows of oil and dilution water are controlled by way of a water flow valve 54 and a water flow monitoring device 56. The static mixer 60 and valve 58 mixes the water with the oil to form water droplets. The oil, mixed with dilution water, enters a second stage compact electrostatic coalescer 62, having an electric transformer 64. The water droplets are coalesced and the water and oil enter a second compartment within the settling vessel 46. The separated water is removed from the second compartment through a second stage water outlet 66. The water removed from the settling vessel 46 by way of the first stage water outlet 48 and the second stage water outlet 66 carries with it salts in solution which have been removed from the crude oil. The desalted crude oil leaves the second compartment of the settling vessel 46 through a second stage oil outlet 68 for storage or further processing.

The first and second stage coalescers 42, 62 are compact electrostatic coalescers (CECs), as described in WO 99/62611. These have the advantage that they require less space and are lighter than a more conventional coalescer, such as up-flow coalescers. The smaller size means that it is possible to mount two coalescers onto a single settling vessel. The CEC has the ability to perform at a very low water cut (ratio of water to oil) and hence reduce the amount of dilution water required. For example, the system shown in FIG. 2 can be used with a low consumption of dilution water from the water supply 52 added prior to the second separation stage. In some applications water availability may be restricted, or provision of larger amounts of water may have a significant cost impact.

Another feature associated with the CEC is the use of insulated electrodes tolerating high water cuts and water slugs at the inlet without short-circuiting the electrodes. Additionally, the CEC may be configured to provide a turbulent flow pattern for improved coalescence of water droplets.

Referring to FIG. 3, an alternative arrangement is shown, which utilises the same separation and desalting apparatus as shown in FIG. 2, but with some additional features. Equivalent reference numerals are used for the equivalent features of FIGS. 2 and 3. In the embodiment of FIG. 3, some of the water leaving the settling vessel 46 through the second stage water outlet 66 is fed back to the crude oil inlet 40. Additional dilution water from a dilution water supply 74 is also mixed with the incoming crude oil stream 40 in a static mixer 80. A dilution water valve 76 and a dilution water flow monitor 78 are used to control the flow to ensure that the consumption of dilution water is kept to a minimum. The proportion of the outlet water from the second stage water outlet 66 and the dilution water from the dilution water supply 74 is mixed with the crude oil stream 40 in a static mixer 80 and the overall flow is controlled by a valve 82.

In the embodiment shown in FIG. 3, the amount of water mixed with the crude oil at the inlet can be controlled to ensure that the first stage electrostatic coalescer 42 is operating under optimum conditions. For example, when the water content in the crude oil is low then it can be an effective way to improve the desalting process by increasing the amount of water in the crude oil/water mix before the first stage electrostatic coalescer 42. Furthermore, the salt concentrations in the oil are highest at the inlet to the first separator stage, but are considerably lower in the second stage. The salt concentration in the water leaving the second stage through the second stage water outlet 66 may be considerably lower than the salt concentration leaving the first stage. Recirculating some of the second stage water reduces the salt concentration in the water entering in the first stage and has the effect reducing the salt concentration in the crude entering the second desalting stage. This has the benefit of allowing for a reduced consumption of dilution water 52 to meet a specified salt concentration in the exported crude oil.

The embodiments shown in FIGS. 2 and 3 make use of a single settling vessel 46. This represents a substantial saving in terms of space and weight, when compared with a two vessel desalting process such as that shown in FIG. 1. The use of a single settling vessel is made possible by using the compact electrostatic coalescers 42, 62. These compact coalescers are small enough for two of them to be mounted on top of a single settling vessel 46. In order for the compact desalting process shown in FIGS. 2 and 3 to be effective, the settling vessel 46 must be divided into two compartments. Referring to FIG. 4, in one embodiment, the settling vessel 46 is shown with the first compact electrostatic coalescer 42, and the second compact electrostatic coalescer 62 mounted side by side above the vessel 46. A vertical separating plate 90 separates the settling vessel 46 into a left compartment 91 and a right compartment 92. The oil and water from the first electrostatic compressor 42 enters the left-hand compartment 91 (which is the first compartment referred to above in the embodiments of FIGS. 2 and 3). The oil and water from the second compact electrostatic coalescer 62 enters the right-hand compartment 92 (which is the second compartment referred to in the embodiments of FIGS. 2 and 3).

Referring to FIG. 5, an alternative arrangement is shown in which the settling vessel 46 is divided into an upper compartment 95 and a lower compartment 96 by means of a horizontal dividing plate 94. A side view of this arrangement is shown in FIG. 6 with the first electrostatic coalescer 42 mounted near one end of the settling vessel 46 such that the flow of oil and water from the first electrostatic coalescer enters the upper compartment 95 (which is the first compartment referred to in the embodiments of FIGS. 2 and 3). In the upper compartment 95, the water drops to the bottom part 100 of the compartment, below the broken line shown in FIG. 6. The lighter oil resides in the upper part 102 of the upper compartment 95 above the broken line. It will be appreciated that the broken line shown in the upper compartment of FIG. 6 represents an interface between the oil and water, but is not a feature of the settling vessel 46 itself.

The second compact electrostatic compressor 62 is situated towards the other end of the settling vessel 46. As can be seen in FIG. 6, the upper compartment 95 does not extend to the full length of the settling vessel 46, but ends at a vertical wall 98 a short distance from the end, such that the oil and water from the second electrostatic coalescer 62 enters the settling vessel 46 into the lower compartment 96. The water in the lower compartment 96 settles to the bottom part of the compartment 104, while the oil settles in the upper part of the compartment 106. Water, containing the dissolved salts, is removed from the upper compartment 95 by way of an outlet 48 that extends out through the base of the vessel 46. Water in the lower compartment 96 is removed by way of the second stage outlet 66.

In the arrangement shown in FIG. 7, equivalent components have the same reference numerals as used in the earlier-numbered drawings. The compact electrostatic coalescers (42, 62) are mounted separate from the settling vessel 46.

A bypass line 110 is provided to bypass the first stage coalescer 42 in case of a shut down for maintenance or inspection of the coalescer. Isolation valves 113 and 114 are normally open, but are used to isolate the coalescer 42 when required. The bypass around the coalescer means production may continue during coalescer maintenance, but at a reduced production rate controlled by the valve 112.

A similar optional bypass feature is provided in the second separation stage to bypass the second compact electrostatic coalescer 62, by means of a bypass line 116. As for the first stage coalescer the second stage coalescer 62 my be bypassed during shutdown or inspection by means of isolation valves 119 and 120 while the flow in the bypass line is controlled by valve 118.

In the embodiment shown in FIG. 8, the coalescing of water droplets and the settling are both carried out in a vessel 122. A crude oil stream 121 containing salty water droplets is fed to the vessel 122. Optionally dilution water 123 may be added to the oil stream. The vessel 122 is provided with a first stage compartment 124 and a second stage compartment 126, separated by a vertical wall 125. Each compartment 124, 126 is configured to include an up-flow coalescer. The first stage compartment 124 has an inlet nozzle 128 near the vessel bottom, an oil outlet 130 at the top, a water outlet 132 at the bottom, an internal distribution manifold 134 and an electrostatic grid 144. The second stage compartment 126 has, similarly disposed, an inlet nozzle 139, an oil outlet 143, a water outlet 140, an internal distribution manifold 142 and a grid 146.

The crude oil stream 121, containing an emulsion of water droplets, enters the first stage compartment 124 through the inlet nozzle 128, and is distributed via the distribution manifold 134. The flow moves into the grid 144 where salty water droplets are coalesced into larger droplets. The larger droplets fall to the bottom of the vessel 122 to exit via the water outlet 132. The crude oil rises and leaves via the oil outlet 130.

Dilution water from a dilution water supply 135 is added and mixed into the crude oil by a mixing valve 136 and static mixer 138 providing less salty crude oil to the second stage compartment 126. The crude oil mixed with water enters the second stage compartment 126 through the second stage inlet nozzle 139 and the internal flow distribution and coalescence occurs in the second stage compartment 126 in same manner as described above for the first stage. Desalted crude leaves from the second stage oil outlet 143 at the top of the vessel 122.

Water leaves the second stage compartment 126 through the outlet 140. This water is less salty than the water leaving the first stage through the first stage water outlet 132, and may be recirculated back into the crude oil upstream of the desalting process to reduce consumption of added dilution water. Dilution water may also be added upstream the desalting process to achieve a minimum water requirement or to reduce the requirement for downstream addition of dilution water.

1. A compact desalting system for use in a process of desalting crude oil comprising a plurality of separation stages, each separation stage including a compact electrostatic coalescer for coalescing water droplets carried with the crude oil and settling means for settling separated oil and coalesced water droplets, wherein the system includes a vessel comprising a plurality of compartments containing said settling means and said compact electrostatic coalescers are each mounted in a housing on top of said vessel.

2. (canceled)

3. (canceled)

4. A compact desalting system according to claim 1 wherein the compact electrostatic coalescers include insulated electrodes tolerating high water cuts and water slugs without short circuiting the electrodes.

5. A compact desalting system according to claim 1 wherein the compact electrostatic coalescers are configured to include a turbulent flow pattern for improved coalescence of water droplets.

6. A compact desalting system according to claim 1 wherein means are provided for mixing dilution water into the crude oil prior to a second separation stage, and wherein the compact electrostatic coalescer at the second separation stage is configured to operate at very low water cut.

7. A compact desalting system according to claim 6 wherein the mixing means includes a static mixer.

8. A compact desalting system according to claim 7 wherein the static mixer is used in combination with a valve.

9. A compact desalting system according to claim 6 wherein the dilution water is added to the crude oil before it enters the first separation stage.

10. A compact desalting system according to claim 1 wherein water from an outlet of a second separator stage is recycled to be mixed with the crude oil before the inlet to the first separator stage.

11. A method of desalting a crude oil stream in a plurality of separation stages, comprising:
electrostatically coalescing water droplets carried in the crude oil stream in a first compact electrostatic coalescer and then separating the coalesced water droplets from the oil in a first compartment of a vessel; and
electrostatically coalescing water droplets carried in the crude oil stream in a second compact electrostatic coalescer and then separating the coalesced water droplets from the oil in a in a second compartment of said vessel.

12. A method according to claim 11, including mixing dilution water into the crude oil.

13. A method according to claim 12 wherein the mixing is performed in a static mixer used in combination with a valve.

14. A method according to claim 12 wherein the dilution water is added to the crude oil after the first separation stage and before the second separation stage.

15. A method according to claim 12 wherein the dilution water is added to the crude oil before it enters the first separation stage.

16. A method according to claim 11 wherein water from an outlet of the second separation stage is recycled to be mixed with the crude oil before the inlet to the first separation stage.

17. A settling vessel for a compact crude oil desalting process having a plurality of separation stages, the settling vessel comprising:
a first compartment containing at least part of a first separation stage; and
a second compartment containing at least part of a second separation stage, the first and second compartments each having separate outlets for oil and water, and wherein the first compartment has a first inlet and the second compartment has a second inlet, the first and second inlets being arranged such that compact electrostatic coalescers are mountable directly on top of the vessel.

18. A vessel according to claim 17 wherein the vessel is of a generally cylindrical form and has a dividing plate dividing the vessel into said first and second compartments.

19. A vessel according to claim 18 wherein the dividing plate is a vertical plate extending the entire length of the vessel.

20. A vessel according to claim 18 wherein the dividing plate is a horizontal plate, the first and second compartments being an upper compartment and a lower compartment.

21. A compact desalting system for use in a process of desalting crude oil comprising a plurality of separation stages, each separation stage including a compact electrostatic coalescer for coalescing water droplets carried with the crude oil and settling means for settling separated oil and coalesced water droplets, wherein the system includes a vessel comprising a plurality of compartments containing said settling means and said compact electrostatic coalescers are each mounted in a housing separate from said vessel.

22. A compact desalting system according to claim 21, wherein at least one of said separation stages includes bypass means for isolating said compact electrostatic coalescer to permit maintenance of the coalescer without stopping operation of the desalting process.

23. A compact desalting system according to claim 21 wherein the compact electrostatic coalescers include insulated electrodes tolerating high water cuts and water slugs without short circuiting the electrodes.

24. A compact desalting system according to claim 21 wherein the compact electrostatic coalescers are configured to include a turbulent flow pattern for improved coalescence of water droplets.

25. A compact desalting system according to claim 21 wherein means are provided for mixing dilution water into the crude oil prior to a second separation stage, and wherein the compact electrostatic coalescer at the second separation stage is configured to operate at very low water cut.

26. A compact desalting system according to claim 25 wherein the mixing means includes a static mixer.

27. A compact desalting system according to claim 26 wherein the static mixer is used in combination with a valve.

28. A compact desalting system according to claim 25 wherein the dilution water is added to the crude oil before it enters the first separation stage.

29. A compact desalting system according to claim 21 wherein water from an outlet of a second separator stage is recycled to be mixed with the crude oil before the inlet to the first separator stage.
